(19) United States
(12) Patent Application Publication
(10) Pub. No.: US 2021/0189123 A1
(43) Pub. Date: Jun. 24, 2021

(54) FLAME-RETARDANT POLYAMIDE COMPOSITION

(71) Applicant: CLARIANT PLASTICS & COATINGS LTD, Muttenz (CH)

(72) Inventors: Sebastian HOEROLD, Diedorf (DE); Elke SCHLOSSER, Augsburg (DE)

(73) Assignee: CLARIANT PLASTICS & COATINGS LTD, Muttenz (CH)

(21) Appl. No.: 16/080,451

(22) PCT Filed: Feb. 20, 2017
(86) PCT No.: PCT/EP2017/053740

§ 371 Date: Aug. 28, 2018

(30) Foreign Application Priority Data
Feb. 29, 2016 (DE) 10 2016 203 221.6

(51) Int. Cl. C08L 77/00; C08K 5/5313; C08K 5/521; C08K 5/5393; C08K 5/3492; C08K 7/14; C08K 5/098

(52) U.S. Cl. CPC C08L 77/00; C08K 5/5313; C08K 5/521; C08K 5/5393; C08K 5/34922; C08L 2203/30; C08K 5/098; C08K 2201/005; C08L 2201/02; C08L 2203/20; C08K 7/14

(57) ABSTRACT

The invention relates to a flame-retardant, polyamide composition containing: as component A) 1 to 96 wt. % of one or more thermoplastic polyamides; as component B) 2 to 25 wt. % of a dialkylphosphinic acid salt of formula (I), where R1 and R2 are the same or different and represent linear, branched or cyclical C1-C18 alkyl, C6-C18 aryl, C7-C18 aryl alkyl and/or C7-C18 alkylaryl; M represents Mg, Ca, Al, Sb, Sn, Ge, Ti, Zn, Fe, Zr, Ce, Bi, Sr, Mn, Li, Na, K and/or a protonated nitrogen base; m is 1 to 4; n is 1 to 4; as component C) 1 to 20 wt. % of a salt of phosphoric acid; as component D) 1 to 20 wt. % of one or more condensation products of melamine; as component E) 0 to 50 wt. % of a filler and/or reinforcing agent; as component F) 0 to 2 wt. % of a phosphite or phosphonite or mixtures thereof; and as component G) 0 to 2 wt. % of an ester or salt of long-chained aliphatic carboxylic acids (fatty acids) which typically have chain lengths of C14 to C40, the sum of the components always amounting to 100 wt. %. The invention also relates to the use of said composition.

The present invention relates to a flame-retardant polyamide composition and to shaped bodies comprising said flame-retardant polyamide composition.

Owing to their chemical composition, many plastics are readily combustible. In order to be able to attain the high flame retardancy demands made by plastics processors and in some cases by the legislator, plastics generally have to be modified with flame retardants. For this purpose, a multitude of different flame retardants and flame retardant synergists are known and also commercially available. Owing to their more advantageous secondary fire characteristics with regard to smoke gas density and small gas composition and for environmental reasons, nonhalogenated flame retardant systems have been used with preference for some time.

Among the nonhalogenated flame retardants, the salts of phosphinic acids (phosphinates) have been found to be very effective particularly for thermoplastic polymers (DE-A-2252258 and DE-A-2447727). Some derivatives of this class of flame retardant are valued owing to their minor adverse effect on the mechanical properties of the thermoplastic molding compounds and are used accordingly.

In addition, synergistic combinations of phosphinates with particular nitrogen-containing compounds, especially with melamine derivatives, have been found, and these have been found to be more effective as flame retardants in a whole series of polymers than the phosphinates alone (WO-A-2002/28953, WO-A-97/01664, and also DE-A-19734437 and DE-A-19737727).

In addition, it has been found that the flame retardancy of the various phosphinates in thermoplastic polymers can also be distinctly improved by addition of small amounts of organic or mineral compounds that do not contain any nitrogen, and that the additives mentioned can also improve the flame retardancy of phosphinates in combination with nitrogen-containing synergists (EP-A-0024167, WO-A-2004/016684). Particularly the combination of phosphinates with melamine polyphosphate leads to V-0 classifications in polyamides according to the UL 94 test.

When phosphinate-containing flame retardant systems are used, however, particularly at processing temperatures above 300° C., there was initially partial polymer degradation, discoloration of the polymer and evolution of smoke in the course of processing. However, it was possible to attenuate these difficulties by addition of basic or amphoteric oxides, hydroxides, carbonates, silicates, borates or stannates (WO-A-2004/022640).

For further improvement of thermal stability, WO 2012/045414 suggests the combination of a phosphinic salt with a salt of phosphorous acid. The flame retardancy of the phosphinic salts can be distinctly improved, especially in aliphatic polyamides. Compared to the use of melamine polyphosphate as synergist, no exudation after storage under moist and warm conditions is observed. WO-A-2014/135256 describes flame-retardant polyamides comprising a phosphinic salt and a salt of phosphorous acid as synergists, and also reinforcers and further additives. The polyamide molding compounds thus obtained show good thermal stability and no tendency to migrate. The UL 94 V-0 fire class is attained, as is a creep resistance (comparative tracking index, CTI) of 600 volts.

Halogen-free polyamide compositions show frequently inadequate glow wire results with regard to the glow wire ignition temperature (GWIT) according to IEC 60335, meaning that there is a unwanted ignition of the polyamide at the glow wire tip at 750° C. A GWIT of 750° C. or higher is required for the use of flame-retardant polyamide molding compounds in domestic appliances that are left unattended.

US-A-2007/299171 describes thermoplastics, especially polyamides, comprising a phosphinic salt (F1), a reaction product of melamine and phosphoric acid (F2) and a condensation product of melamine (F3), where F1+F2 are at least 13%, preferably at least 15%, based on the overall composition. The simultaneous use of F1, F2 and F3 achieves a GWIT of 775° C. A disadvantage of such formulations is that the use of reaction products of melamine and phosphoric acid can result in migration effects. Moreover, thermal stability is limited to about 300° C., there can be polymer degradation and breakdown at even higher processing temperatures.

US 2014/0371357 describes thermoplastic polyamides comprising 10-40% by weight of glass fibers, 10-40% by weight of melam and 0-15% by weight of a halogen-free flame retardant, where the polyamide contains up to 10 mol % of aromatic monomer units. A GWIT of at least 800° C. is attained; the halogen-free flame retardant may be a metal phosphinate. A disadvantage of the use of melam is the high filler level of 30-35% in order to attain UL 94 V-0 and GWIT >750° C., which reduces the flowability and mechanical properties of the polyamide compounds.

It was therefore an object of the present invention to provide halogen-free flame-retardant thermoplastic polyamide compositions (molding compounds) based on phosphinate-containing flame retardant systems, which have high thermal stability and good mechanical properties, reliably attain both UL 94 V-0 up to specimen wall thickness 0.4 mm and the glow wire requirements of glow wire flammability index (GWFI) 960° C. and GWIT 775° C. for all wall thicknesses tested, do not show any migration effects and show good flowability and high electrical values (comparative tracking index (CTI) >550 V).

It has now been found that, surprisingly, the glow wire resistance of phosphonate-containing flame-retardant thermoplastic polyamides can be distinctly improved when the molding compound, in addition to the phosphinates (component B)), comprises a salt of phosphorous acid (also referred to as phosphonic acid) HP(═O)(OH)₂ (component C)) and a condensation product of melamine (component D)). In the case of the specific combination, the balanced profile of properties of the polyamides with regard to electrical and mechanical properties is substantially conserved. The molding compounds thus obtained surprisingly do not show any migration of the flame retardant used. The polyamide composition (molding compound) further comprises fillers and/or reinforcers as component E).

Thermoplastic polymers are processed predominantly in the melt. Barely any polymer withstands the associated changes in structure and state without any change in its chemical structure. Crosslinking, oxidation, changes in molecular weight and hence also changes in the physical and technical properties may be the result. In order to reduce stress on the polymers during processing, different additives are added according to the polymer.

Different additives are often used at the same time, each of which takes on a particular task. For instance, antioxidants and stabilizers are used in order that the polymer withstands processing without chemical damage and then has a sufficient period of stability with respect to outside influences such as heat, UV light, weathering and oxygen (air). In addition to improving flow characteristics, lubricants prevent excessive adhesion of the polymer melt to hot machine parts and act as a dispersant for pigments, fillers and reinforcers.

The use of flame retardants can influence the stability of polymers in the course of processing in the melt. Flame retardants frequently have to be added in high dosages in order to ensure sufficient flame retardancy of the plastic according to international standards. Due to their chemical reactivity, which is required for flame retardancy at high temperatures, flame retardants can impair the processing stability of polymers. This may result, for example, in increased polymer degradation, crosslinking reactions, outgassing or discoloration.

Polyamides are stabilized, for example, by small amounts of copper halides and aromatic amines, and sterically hindered phenols, with emphasis on the achievement of long-term stability at high sustained use temperatures (H. Zweifel (ed.): “Plastics Additives Handbook”, 5th Edition, Carl Hanser Verlag, Munich, 2000, pages 80 to 84).

The polyamide composition of the invention may comprise, as component F), a phosphonite or a phosphite or a phosphonite/phosphite mixture and, as component G), an ester or salt of long-chain aliphatic carboxylic acids (fatty acids) which typically have chain lengths of C₁₄ to C₄₀.

The invention therefore provides a flame-retardant polyamide composition comprising

as component A) 1% to 96% by weight of one or more thermoplastic polyamides,
as component B) 2% to 25% by weight of a dialkylphosphinic salt of the formula (I)

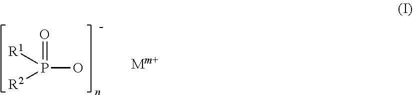

in which
R¹ and R² are the same or different and are C₁-C₁₈-alkyl in linear, branched or cyclic form, C₆-C₁₈-aryl, C₇-C₁₈-arylalkyl and/or C₇-C₁₈-alkylaryl,
M is Mg, Ca, Al, Sb, Sn, Ge, Ti, Zn, Fe, Zr, Ce, Bi, Sr, Mn, Li, Na, K and/or a protonated nitrogen base;
m is 1 to 4;
n is 1 to 4;
   as component C) 1% to 20% by weight of a salt of phosphorous acid,
   as component D) 1% to 20% by weight of one or more condensation products of melamine,
   as component E) 0% to 50% by weight of filler and/or reinforcer,
   as component F) 0% to 2% by weight of phosphite or phosphonite or mixtures thereof, and as component G) 0% to 2% by weight of an ester or salt of long-chain aliphatic carboxylic acids (fatty acids) which typically have chain lengths of C₁₄ to C₄₀, where the sum total of the components is always 100% by weight.

Preferably, the flame-retardant polyamide composition comprises

15% to 89.9% by weight of component A),
5% to 20% by weight of component B),
2% to 10% by weight of component C),
2% to 20% by weight of component D),
1% to 50% by weight of component E),
0% to 2% by weight of component F) and
0.1% to 1% by weight of component G).

More preferably, the flame-retardant polyamide composition comprises

15% to 75.8% by weight of component A),
5% to 20% by weight of component B),
2% to 10% by weight of component C),
2% to 10% by weight of component D),
15% to 35% by weight of component E),
0.1% to 1% by weight of component F) and
0.1% to 1% by weight of component G).

Especially preferably, the flame-retardant polyamide composition comprises

35% to 65.8% by weight of component A),
5% to 20% by weight of component B),
2% to 7% by weight of component C),
2% to 7% by weight of component D),
25% to 35% by weight of component E),
0.1% to 5% by weight of component F) and
0.1% to 5% by weight of component G).

In another embodiment, the flame-retardant polyamide composition comprises

35% to 96% by weight of component A),
2% to 25% by weight of component B),
1% to 20% by weight of component C),
1% to 20% by weight of component D),
0% to 50% by weight of component E),
0% to 2% by weight of component F) and
0% to 2% by weight of component G).

Preferably, the flame-retardant polyamide composition has a comparative tracking index (CTI), measured according to International Electrotechnical Commission Standard IEC 60112/3, of greater than 550 volts.

Preferably, the flame-retardant polyamide composition attains a V-0 assessment according to UL 94 at a specimen thickness of 3.2 mm to 0.4 mm.

Preferably, the flame-retardant polyamide composition has a glow wire flammability index (GWFI) according to IEC 60695-2-12 of 960° C. at a specimen thickness of 0.4 to 3 mm.

Preferably, the flame-retardant polyamide composition has a glow wire ignition temperature index (GWIT) according to IEC 60695-2-13 of 750° C. or more at a specimen thickness of 0.4 to 3 mm.

Preferably, the polyamide (PA) is selected from the group of PA 6, PA 6,6, PA 4,6, PA 12, PA 6,10, PA 4,10, PA 10,10, PA 11, PA 6T/66, PA 6T/6, PA 4T, PA 9T, PA 10T, polyamide copolymers, polyamide blends and combinations thereof.

Preferably, component A) is nylon-6,6 or copolymers or polymer blends of nylon-6,6 and nylon-6.

Preferably, component A) is polyamide PA 6T/66, PA 6T/6, PA 4T, PA 9T and/or PA 10T.

Preferably characterized in that component D) is melam, melem and/or melon.

More preferably, component D) is melem.

Preferably, in component B), R¹, R² are the same or different and are each methyl, ethyl, n-propyl, isopropyl, n-butyl, tert-butyl, n-pentyl and/or phenyl.

Preferably, the salt of phosphorous acid (component C)) conforms to the formula (II)

[HP(═O)O₂]²⁻M^{m+} (II)

in which
M is Mg, Ca, Al, Sb, Sn, Ge, Ti, Zn, Fe, Zr, Ce, Bi, Sr, Mn, Li, Na and/or K.

Preferably, the salt of phosphorous acid (component C)) is aluminum phosphite Al(H₂PO₃)₃, secondary aluminum phosphite Al₂(HPO₃)₃, aluminum phosphite tetrahydrate Al₂(HPO₃)₃*4 aq, aluminum phosphonate, basic aluminum phosphite Al(OH)(H₂PO₃)₂*2 aq, Al₇(HPO₃)₉(OH)₆(1,6-hexanediamine)_{1.5}*12H₂O, Al₂(HPO₃)₃*xAl₂O₃*nH₂O with x=1-2.27 and n=1-50 and/or Al₄H₆P₁₆O₁₈.

Preferably, the salt of phosphorous acid also comprises aluminum phosphites of the formula (III), (IV) and/or (V), where

Al₂(HPO₃)₃ x(H₂O)q Formula (III):

and
q is 0 to 4

Al_{2.00}M_{z}(HPO₃)_{y}(OH)ᵥx(H₂O)_{w} Formula (IV):

and
M represents alkali metal ions,
z is 0.01 to 1.5,
y is 2.63 to 3.5,
v is 0 to 2 and
w is 0 to 4;

Al_{2.00}(HPO₃)ᵤ(H₂PO₃)ₜx(H₂O)ₛ Formula (V):

and
u is 2 to 2.99 and
t is 2 to 0.01 and

### s is Oto 4,

and/or comprises mixtures of aluminum phosphite of the formula (III) with sparingly soluble aluminum salts and nitrogen-free extraneous ions, mixtures of aluminum phosphite of the formula (V) with aluminum salts, mixtures of aluminum phosphite of the formulae (III), (IV) and/or (V) with aluminum phosphite [Al(H₂PO₃)₃], with secondary aluminum phosphite [Al₂(HPO₃)₃], with basic aluminum phosphite [Al(OH)(H₂PO₃)₂*2 aq], with aluminum phosphite tetrahydrate [Al₂(HPO₃)₃*4 aq], with aluminum phosphonate, with Al₇(HPO₃)₉(OH)₆(1,6-hexanediamine)_{1.5}*12H₂O, with Al₂(HPO₃)₃*xAl₂O₃*nH₂O with x=1-2.27 and n=1-50 and/or with Al₄H₆P₁₆O₁₈.

Preferably, component C) has an average particle size of 0.2 to 100 μm.

Preferably, the reinforcing filler or reinforcer (component E)) comprises glass fibers.

Preference is given to using, as component F, phosphites of the formula (IX)

P(OR₁)₃ (IX)

The phosphonites are preferably those of the general structure

R—[P(OR⁵)₂]ₘ (VI)

where
R is a mono- or polyvalent aliphatic, aromatic or heteroaromatic organic radical and
R⁵ is a compound of the structure (XII)

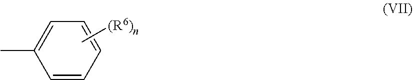

or the two R⁵ radicals form a bridging group of the structure (VIII)

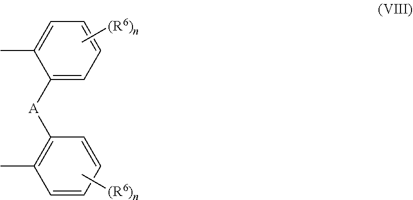

with
A is a direct bond, O, S, C₁₋₁₈-alkylene (linear or branched), C₁₋₁₈-alkylidene (linear or branched), in which
R⁶ is independently C₁₋₁₂-alkyl (linear or branched), C₁₋₁₂-alkoxy and/or C₅₋₁₂-cycloalkyl and
n is 0 to 5 and
m is 1 to 4.

Component G) preferably comprises alkali metal, alkaline earth metal, aluminum and/or zinc salts of long-chain fatty acids having 14 to 40 carbon atoms and/or reaction products of long-chain fatty acids having 14 to 40 carbon atoms with polyhydric alcohols such as ethylene glycol, glycerol, trimethylolpropane and/or pentaerythritol.

The flame-retardant polyamide composition of the invention as claimed in one or more of claims 1 to 22 may further comprise telomers.

Telomers in the narrower sense can form through the multiple addition of olefins (ethylene, propylene) onto the phosphoric acid source (H₃PO₂, sodium hypophosphite).

Preferably, the telomers in that case are those of the formula (X)

H—(C_{w}H_{2w})ₖP(O)(OM)(CₓH₂ₓ)ₗ—H (X)

where, in formula (X), independently of one another,
k is 1 to 9,
l is 1 to 9,
w is 2 to 9,
x is 2 to 9,
M is Mg, Ca, Al, Sb, Sn, Ge, Ti, Fe, Zr, Zn, Ce, Bi, Sr, Mn, Li, Na, K and/or a protonated nitrogen base,
   and the (C_{w}H_{2w})ₖ and (CₓH₂ₓ)ₗ groups may be linear or branched;

Preferably, the telomers are metal salts of ethylbutylphosphinic acid, dibutylphosphinic acid, ethylhexylphosphinic acid, butylhexylphosphinic acid, ethyloctylphosphinic acid, sec-butylethylphosphinic acid, 1-ethylbutyl(butyl)phosphinic acid, ethyl(1-methylpentyl)phosphinic acid, di-sec-butylphosphinic acid (di(1-methylpropyl)phosphinic acid), propyl(hexyl)phosphinic acid, dihexylphosphinic acid, hexyl(nonyl)phosphinic acid, propyl(nonyl)phosphinic acid, dinonylphosphinic acid, dipropylphosphinic acid, butyl(octyl)phosphinic acid, hexyl(octyl)phosphinic acid, dioctylphosphinic acid.

Telomers in the wider sense can also form through the addition of the phosphoric acid source onto organic radicals which can form, for example, from free-radical initiator and solvent.

In that case, the telomers are those of the formula (XI)

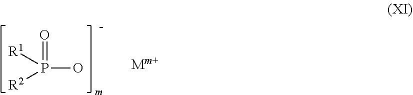

in which
R¹, R² are the same or different and are C₆-C₁₀-arylene, C₇-C₂₀-alkylarylene, C₇-C₂₀-arylalkylene and/or C₃-C₁₆-cycloalkyl or -bicycloalkyl,
M is Mg, Ca, Al, Sb, Sn, Ge, Ti, Fe, Zr, Zn, Ce, Bi, Sr, Mn, Li, Na, K and/or a protonated nitrogen base.

Preferably, in formula (X),

w and x are each 2 to 4 and
k and l are each 1 to 4.

More preferably, in formula (X),

w and x are each 2 or 3 and
k and l are each 1 to 3.

Preferably, M in formula (X) and/or (XI) is in each case independently Al, Ti, Fe or Zn.

Preferably, the telomers are metal salts of ethyl(cyclopentylethyl)phosphinic acid, butyl(cyclopentylethyl)phosphinic acid, ethyl(cyclohexylethyl)phosphinic acid, butyl(cyclohexylethyl)phosphinic acid, ethyl(phenylethyl)phosphinic acid, butyl(phenylethyl)phosphinic acid, ethyl(4-methylphenylethyl)phosphinic acid, ethylphenylphosphinic acid, butyl(4-methylphenylethyl)phosphinic acid, butylcyclopentylphosphinic acid, butylcyclohexylethylphosphinic acid, butylphenylphosphinic acid, ethyl(4-methylphenyl)phosphinic acid and/or butyl(4-methylphenyl)phosphinic acid, where the metal in the metal salt comes from the group of Mg, Ca, Al, Sb, Sn, Ge, Ti, Fe, Zr, Zn, Ce, Bi, Sr, Mn, Li, Na and/or K.

Telomers in the wider sense can also form through the addition of the phosphoric acid source onto organic radicals which form, for example, in the course of breakdown of photoinitiators.

Hydroxymethylethyl(ethyl)phosphinic acid, 1-hydroxy-1-methylpropyl(ethyl)phosphinic acid, butyl(ethyl)phosphonic esters, acyl(ethyl)phosphonic anhydride, butyl(ethyl)phosphonic acid, butylethylphosphinic acid, ethylphosphinylisobutyronitrile (1-cyano-1-methylethyl(ethyl)phosphinic acid), propylethylphosphinic acid, t-butyl(ethyl)phosphonic esters, t-butyl(ethyl)phosphinic acid, ethylphosphinylacetic acid, hydroxymethylbutyl(ethyl)phosphinic acid, 3-hydroxy-3-methylpentyl(ethyl)phosphinic acid, propoxyethyl(ethyl)phosphinic acid, phenylethyl(ethyl)phosphinic acid, 2-ethylphosphinylethyllauric esters, ethylpentylphosphinic acid, t-butoxyethyl(ethyl)phosphinic acid, ethylphosphinylisohexanonitrile, hexylethylphosphinic acid, ethylphosphinyl ethylsulfate, ethylphosphinylbutyric acid.

The invention also relates to a three-dimensional article comprising the flame-retardant polyamide composition as claimed in one or more of claims 1 to 23, which comprises shaped bodies, injection moldings, extrusion compounds and/or extrudates.

The invention additionally relates to the use of a flame-retardant polyamide composition as claimed in one or more of claims 1 to 23 in or for plug connectors, current-bearing components in power distributors (residual current protection), circuit boards, potting compounds, plug connectors, circuit breakers, lamp housings, LED housings, capacitor housings, coil elements and ventilators, grounding contacts, plugs, in/on printed circuit boards, housings for plugs, cables, flexible circuit boards, charging cables for mobile phones, motor covers, textile coatings and other products.

Preferably, component A consists to an extent of at least 75% by weight of nylon-6,6 and to an extent of at most 25% by weight of nylon-6.

It has been found that, surprisingly, the flame-retardant polyamide compositions have good flame retardancy (V-0 and GWFI/GWIT) combined with improved flowability, high thermal stability and high impact resistance. Polymer degradation is prevented or very greatly reduced and no mold deposits or exudation are observed. The flame-retardant polyamide compositions of the invention additionally show only slight discoloration on processing in the melt.

As component A), the compositions comprise, in accordance with the invention, at least one thermoplastic polyamide.

According to Hans Domininghaus in “Die Kunststoffe and ihre Eigenschaften” [The Polymers and Their Properties], 5th edition (1998), page 14, thermoplastic polyamides are polyamides wherein the molecular chains have no side branches or else varying numbers of side branches of greater or lesser length, and which soften when heated and are virtually infinitely shapable.

The polyamides preferred in accordance with the invention may be prepared by various methods and be synthesized from very different starting materials and, in the specific application case, may be modified alone or in combination with processing auxiliaries, stabilizers or else polymeric alloy partners, preferably elastomers, to give materials having specifically established combinations of properties. Also suitable are blends with proportions of other polymers, preferably of polyethylene, polypropylene, ABS, in which case it is optionally possible to use one or more compatibilizers. The properties of the polyamides can be improved by addition of elastomers, for example with regard to impact resistance, especially when the polyamides are reinforced polyamides. The multitude of possible combinations enables a very large number of products having a wide variety of different properties.

A multitude of procedures are known for preparation of polyamides, using different monomer units, various chain transfer agents for establishment of a desired molecular weight or else monomers having reactive groups for intended later aftertreatments according to the end product desired.

The processes of industrial relevance for preparation of polyamides usually proceed by polycondensation in the melt. This is also understood to include the hydrolytic polymerization of lactams as a polycondensation.

Polyamides for use with preference as component A) are semicrystalline polyamides (PA) which can be prepared proceeding from diamines and dicarboxylic acids and/or lactams having at least 5 ring members or corresponding amino acids.

Useful reactants include aliphatic and/or aromatic dicarboxylic acids, preferably adipic acid, 2,2,4- and 2,4,4-trimethyladipic acid, azelaic acid, sebacic acid, isophthalic acid, terephthalic acid, aliphatic and/or aromatic diamines, preferably tetramethylenediamine, hexamethylenediamine, nonane-1,9-diamine, 2,2,4- and 2,4,4-trimethylhexamethylenediamine, the isomeric diaminodicyclohexylmethanes, diaminodicyclohexylpropanes, bisaminomethylcyclohexane, phenylenediamines, xylylenediamines, aminocarboxylic acids, preferably aminocaproic acid, or the corresponding lactams. Copolyamides formed from two or more of the monomers mentioned are included. Particular preference is given to using caprolactams, very particular preference to using [epsilon]-caprolactam.

Also particularly suitable are most compounds based on PA 6, PA 66 and other aliphatic or/and aromatic polyamides or copolyamides in which there are 3 to 11 methylene groups for every polyamide group in the polymer chain.

Preferably, the aliphatic polyamides and copolyamides are nylon-12, nylon-4, nylon-4,6, nylon-6, nylon-6,6, nylon-6,9, nylon-6,10, nylon-6,12, nylon-6,66, nylon-7,7, nylon-8,8, nylon-9,9, nylon-10,9, nylon-10,10, nylon-11, nylon-12, etc. These are known, for example, by the trade names Nylon®, from DuPont, Ultramid®, from BASF, Akulon®, from DSM, Zytel®, from DuPont; Durethan®, from Bayer and Grillamid®, from Ems Chemie.

Also suitable with preference are aromatic polyamides proceeding from m-xylene, diamine and adipic acid; polyamides prepared from hexamethylenediamine and iso- and/or terephthalic acid and optionally an elastomer as a modifier, for example poly-2,4,4-trimethylhexamethyleneterephthalamide or poly-m-phenyleneisophthalamide, block copolymers of the aforementioned polyamides with polyolefins, olefin copolymers, ionomers or chemically bound or grafted elastomers, or with polyethers, for example with polyethylene glycol, polypropylene glycol or polytetramethylene glycol. In addition, EPDM- or ABS-modified polyamides or copolyamides, and polyamides condensed during processing (“RIM polyamide systems”).

In a preferred embodiment, the compositions of the invention comprise, as well as the thermoplastic polyamide for use in accordance with the invention, at least one further thermoplastic polymer, more preferably at least one other polyamide.

Preference is given to aliphatic polyamides, especially PA6 and PA66 and PA 6T/66 and PA 6T/6. Very particular preference is given to mixtures of nylon-6,6 and nylon-6 with preferably more than 50% by weight of nylon-6,6 and less than 50% by weight of nylon-6, and more preferably less than 25% by weight of nylon-6, based in each case on the total amount of polyamide.

Preference is also given to blends of nylon-6,6 and one or more semiaromatic amorphous polyamides.

Standard additives, especially demolding agents, stabilizers and/or flow auxiliaries, may be mixed into the melt or applied to the surface of polymers to be used in addition to the thermoplastic polyamide in a preferred embodiment. Starting materials for the thermoplastic polyamides of component A) may have a synthetic origin, for example from petrochemical raw materials, and/or may have originated from renewable raw materials via chemical or biochemical processes.

Other flame retardants or flame retardant synergists that are not mentioned specifically here may also be employed. Particularly nitrogen-containing flame retardant such as melamine cyanurate, melamine phosphates and melamine polyphosphate may be added. It is also possible to use further phosphorus flame retardant such as aryl phosphates or red phosphorus. In addition, it is also possible to use salts of aliphatic and aromatic sulfonic acids and mineral flame retardant additives such as aluminium hydroxide and/or magnesium hydroxide, calcium magnesium carbonate hydrates (e.g. DE-A-4236122). Also useful are flame retardant synergists from the group of the oxygen-, nitrogen- or sulfur-containing metal compound, preferably zinc oxide, zinc borate, zinc stannate, zinc hydroxystannate, zinc sulfide, molybdenum oxide, titanium dioxide, magnesium oxide, magnesium carbonate, calcium carbonate, calcium oxide, titanium nitride, boron nitride, magnesium nitride, zinc nitride, zinc phosphate, calcium phosphate, calcium borate, magnesium borate or mixtures thereof.

Further flame retardant additives that are suitable with preference are charcoal formers, more preferably phenol-formaldehyde resins, polycarbonate, polyimides, polysulfones, polyethersulfones or polyetherketones, and anti-dripping agents, especially tetrafluoroethylene polymers.

The flame retardant is may be added in pure form, or else via masterbatches or compactates.

Preferably, component B is the aluminum salt or zinc salt of diethylphosphinic acid.

Preferably, in the aluminum phosphite of the formula (III),

q is 0.01 to 0.1.

Preferably, in the aluminum phosphite of the formula (IV),

z is 0.15 to 0.4;
y is 2.80 to 3;
v is 0.1 to 0.4 and
w is 0.01 to 0.1.

Preferably, in the aluminum phosphite of the formula (V),

u is 2.834 to 2.99;
t is 0.332 to 0.03 and
s is 0.01 to 0.1.

Preferably, the condensed melamine compounds are melam or melem.

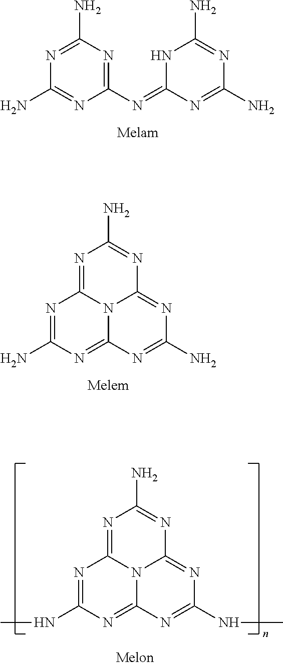

As component E), the flame-retardant polyamide compositions of the invention, in a further preferred embodiment, may comprise at least one filler or reinforcer.

It is also possible here to use mixtures of two or more different fillers and/or reinforcers, preferably based on talc, mica, silicate, quartz, titanium dioxide, wollastonite, kaolin, amorphous silicas, nanoscale minerals, more preferably montmorillonites or nanoboehmite, magnesium carbonate, chalk, feldspar, barium sulfate, glass beads and/or fibrous fillers and/or reinforcers based on carbon fibers and/or glass fibers. Preference is given to using mineral particulate fillers based on talc, mica, silicate, quartz, titanium dioxide, wollastonite, kaolin, amorphous silicas, magnesium carbonate, chalk, feldspar, barium sulfate and/or glass fibers. Particular preference is given to using mineral particulate fillers based on talc, wollastonite, kaolin and/or glass fibers, very particular preference being given to glass fibers.

Particular preference is further also given to using acicular mineral fillers. Acicular mineral fillers are understood in accordance with the invention to mean a mineral filler having highly pronounced acicular character. Examples include acicular wollastonites. Preferably, the mineral has a length to diameter ratio of 2:1 to 35:1, more preferably of 3:1 to 19:1, especially preferably of 4:1 to 12:1. The average particle size of the acicular minerals usable in accordance with the invention is preferably less than 20 μm, more preferably less than 15 μm, especially preferably less than 10 μm, determined with a CILAS granulometer.

The filler and/or reinforcer may, in a preferred embodiment, have been surface-modified, preferably with an adhesion promoter or adhesion promoter system, more preferably a silane-based adhesion promoter system. However, the pretreatment is not absolutely necessary. Especially in the case of use of glass fibers, in addition to silanes, it is also possible to use polymer dispersions, film formers, branching agents and/or glass fiber processing auxiliaries.

The glass fibers for use with very particular preference in accordance with the invention as component E), which generally have a fiber diameter between 7 and 18 μm, preferably between 9 and 15 μm, are added in the form of continuous fibers or in the form of chopped or ground glass fibers. These fibers may have been modified with a suitable sizing system and an adhesion promoter or adhesion promoter system, preferably based on silane.

The polyamide compositions of the invention may also comprise further additives. Preferred additives in the context of the present invention are antioxidants, UV stabilizers, gammaray stabilizers, hydrolysis stabilizers, antistats, emulsifiers, nucleating agents, plasticizers, processing auxiliaries, impact modifiers, dyes and pigments. The additives may be used alone or in a mixture or in the form of masterbatches.

Suitable antioxidants are, for example, alkylated monophenols, e.g. 2,6-di-tert-butyl-4-methylphenol; alkylthiomethylphenols, e.g. 2,4-dioctylthiomethyl-6-tert-butylphenol; hydroquinones and alkylated hydroquinones, e.g. 2,6-di-tert-butyl-4-methoxyphenol; tocopherols, e.g. α-tocopherol, β-tocopherol, γ-tocopherol, tocopherol and mixtures thereof (vitamin E); hydroxylated thiodiphenyl ethers, e.g. 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-di-methyl-4-hydroxyphenyl) disulfide; alkylidenebisphenols, e.g. 2,2′-methylenebis(6-tert-butyl-4-methylphenol); O-, N- and S-benzyl compounds, e.g. 3,5,3′,5′-tetra-tert-butyl-4,4′-dihydroxydibenzyl ether; hydroxybenzylated malonates, e.g. dioctadecyl 2,2-bis(3,5-di-tert-butyl-2-hydroxybenzyl)malonate; hydroxybenzyl aromatics, e.g. 1,3,5-tris-(3,5-di-tert-butyl)-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris-(3,5-di-tert-butyl-4-hydroxybenzyl)phenol; triazine compounds, e.g. 2,4-bisoctylmercapto-6-(3,5-di-tert-butyl-4-hydroxyanilino)-1,3,5-triazine, benzyl phosphonates, e.g. dimethyl 2,5-di-tert-butyl-4-hydroxybenzylphosphonate; acylaminophenols, 4-hydroxylauramide, 4-hydroxystearanilide, N-(3,5-di-tert-butyl-4-hydroxyphenyl)carbamic acid octyl ester; esters of β-(3,5-di-tert-butyl-4-hydroxyphenyl)propionic acid with mono- or polyhydric alcohols; esters of β-(5-tert-butyl-4-hydroxy-3-methylphenyl)propionic acid with mono- or polyhydric alcohols; esters of β-(3,5-dicyclohexyl-4-hydroxyphenyl)propionic acid with mono- or polyhydric alcohols; esters of 3,5-di-tert-butyl-4-hydroxyphenylacetic acid with mono- or polyhydric alcohols; amides of β-(3,5-di-tert-butyl-4-hydroxyphenyl)propionic acid, for example N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine, N,N′-bis(3,5-di-tert-butyl-4-hydroxyphenylpropionyl)hydrazine.

Particular preference is given to using sterically hindered phenols alone or in combination with phosphites, very particular preference being given to the use of N, N′-bis[3-(3′,5′-di-tert-butyl-4′-hydroxyphenyl)propionyl]hexamethylenediamine (e.g. Irganox® 1098 from BASF SE, Ludwigshafen, Germany).

Suitable UV absorbers and light stabilizers are, for example, 2-(2′-hydroxyphenyl)benzotriazoles, for example 2-(2′-hydroxy-5-methylphenyl)benzotriazole;

2-hydroxybenzophenones, for example the 4-hydroxy, 4-methoxy, 4-octoxy, 4-decyloxy, 4-dodecyloxy, 4-benzyloxy, 4,2′,4-trihydroxy, 2′-hydroxy-4,4′-dimethoxy derivative;
esters of optionally substituted benzoic acids, for example 4-tert-butylphenyl salicylate, phenyl salicylate, octylphenyl salicylate, dibenzoylresorcinol, bis(4-tert-butylbenzoyl)resorcinol, benzoylresorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate, acrylates, for example ethyl or isooctyl α-cyano-β,β-diphenylacrylate, methyl α-carbomethoxycinnamate, methyl or butyl α-cyano-β-methyl-p-methoxycinnamate, methyl α-carbomethoxy-p-methoxycinnamante, N-(β-carbomethoxy-β-cyanovinyl)-2-methylindoline.

Colorants used are preferably inorganic pigments, especially titanium dioxide, ultramarine blue, iron oxide, zinc sulfide or carbon black, and also organic pigments, preferably phthalocyanines, quinacridones, perylenes, and dyes, preferably nigrosin and anthraquinones.

Suitable polyamide stabilizers are, for example, copper salts in combination with iodides and/or phosphorus compounds and salts of divalent manganese.

Suitable basic costabilizers are melamine, polyvinylpyrrolidone, dicyandiamide, triallyl cyanurate, urea derivatives, hydrazine derivatives, amines, polyamides, polyurethanes, alkali metal and alkaline earth metal salts of higher fatty acids, for example calcium stearate, zinc stearate, magnesium behenate, magnesium stearate, sodium ricinoleate, potassium palmitate, antimony catecholate or tin catecholate.

Suitable nucleating agents are, for example, 4-tert-butylbenzoic acid, adipic acid and diphenylacetic acid, aluminum oxide or silicon dioxide, and most preferably talc, but this enumeration is non-conclusive.

Flow auxiliaries used are preferably copolymers of at least one α-olefin with at least one methacrylic acid or acrylic ester of an aliphatic alcohol. Particular preference is given to copolymers in which the α-olefin has been formed from ethene and/or propene and methacrylic acid or acrylic ester contains linear or branched alkyl groups having 6 to 20 carbon atoms as alcohol component. Very particular preference is given to (2-ethyl)hexyl acrylate.

Copolymers are suitable in accordance with the invention as flow auxiliaries are notable not only for their composition but also for their low molecular weight. Accordingly, suitable copolymers for the compositions that are to be conserved in accordance with the invention from thermal breakdown are particularly those that have melt flow index (MFI) measured at 190° C. and a load of 2.16 kg of at least 100 g/10 min, preferably of at least 150 g/10 min, more preferably of at least 300 g/10 min. The MFI serves for characterization of the flow of a melt of a thermoplastic and is subject to the standards ISO 1133 or ASTM D 1238. The MFI and all MFI figures in the context of the present invention relate or have been measured/determined uniformly according to ISO 1133 at 190° C. with a test weight of 2.16 kg.

Plasticizers for use with preference are dioctyl phthalate, dibenzyl phthalate, butyl benzyl phthalate, hydrocarbon oils or N-(n-butyl)benzenesulfonamide.

The present invention also relates to products, preferably fibers, films or moldings, obtainable from the compositions described in accordance with the invention by injection molding or extrusion.

Suitable phosphinates (component B)) are described in PCT/WO97/39053, which is explicitly incorporated by reference. Particularly preferred phosphinates are aluminum, calcium and zinc phosphinates.

Preferred salts of phosphorous acid (component C)) are water-insoluble or sparingly water-soluble salts.

Particularly preferred salts of phosphorous acid are the aluminum, calcium and zinc salts.

More preferably, component C) is a reaction product of phosphorous acid and an aluminum compound.

Preference is given to aluminum phosphites having the CAS numbers 15099-32-8, 119103-85-4, 220689-59-8, 56287-23-1, 156024-71-4, 71449-76-8 and 15099-32-8.

The aluminum phosphites preferably have particle sizes of 0.2-100 μm.

The preferred aluminum phosphites are prepared by reaction of an aluminum source with a phosphorus source and optionally a template in a solvent at 20-200° C. over a period of time of up to 4 days. For this purpose, aluminum source and phosphorus source are mixed for 1-4 h, heated under hydrothermal conditions or at reflux, filtered off, washed and dried, for example at 110° C.

Preferred aluminum sources are aluminum isopropoxide, aluminum nitrate, aluminum chloride and aluminum hydroxide (e.g. pseudoboehmite).

Preferred phosphorus sources are phosphorous acid, (acidic) ammonium phosphite, alkali metal phosphites or alkaline earth metal phosphites.

Preferred alkali metal phosphites are disodium phosphite, disodium phosphite hydrate, trisodium phosphite and potassium hydrogenphosphite.

A preferred disodium phosphite hydrate is Brüggolen® H10 from Brüggemann.

Preferred templates are 1,6-hexanediamine, guanidine carbonate or ammonia.

A preferred alkaline earth metal phosphite is calcium phosphite.

The preferred ratio of aluminum to phosphorus to solvent is 1:1:3.7 to 1:2.2:100 mol. The ratio of aluminum to template is 1:0 to 1:17 mol. The preferred pH of the reaction solution is 3 to 9. A preferred solvent is water.

In the application, particular preference is given to using the same salt of phosphinic acid as of phosphorous acid, i.e., for example, aluminum dialkylphosphinate together with aluminum phosphite or zinc dialkylphosphinate together with zinc phosphite.

Component G) preferably comprises alkali metal, alkaline earth metal, aluminum and/or zinc salts of long-chain fatty acids having 14 to 40 carbon atoms and/or reaction products of long-chain fatty acids having 14 to 40 carbon atoms with polyhydric alcohols such as ethylene glycol, glycerol, trimethylolpropane and/or pentaerythritol. Particular preference is given to aluminum stearate, calcium stearate or zinc stearate or calcium montanate.

Suitable further flame retardants are preferably aryl phosphates, phosphonates, salts of hypophosphorous acid and red phosphorus.

Preference is given to using, as component F, phosphites of the formula (IX)

P(OR₁)₃ (IX)

where R₁ is as defined above.

In the case of the phosphonites, the radicals are preferably
R is C₄-C₁₈-alkyl (linear or branched), C₄-C₁₈-alkylene (linear or branched), C₅-C₁₂-cycloalkyl, C₅-C₁₂-cycloalkylene, C₆-C₂₄-aryl or heteroaryl, C₆-C₂₄-arylene or heteroarylene, which may also have further substitution;
R₁ a compound of the structure (IX) or (VI) where
R₂ independently C₁-C₈-alkyl (linear or branched), C₁-C₈-alkoxy, cyclohexyl;
A a direct bond, O, C₁-C₈-alkylene (linear or branched), C₁-C₈-alkylidene (linear or branched) and
n 0 to 3;
m 1 to 3.

In the case of the phosphonites, the radicals are more preferably:
R cyclohexyl, phenyl, phenylene, biphenyl and biphenylene
R₁ a compound of the structure (IX) or (VI) where
R₂ independently C₁-C₈-alkyl (linear or branched), C₁-C₈-alkoxy, cyclohexyl;
A a direct bond, O, C₁-C₆-alkylidene (linear or branched) and
n 1 to 3;
m 1 or 2.

Additionally claimed are mixtures of compounds according to the above claims in combination with phosphites.

Especially preferred are compounds which, based on the above definitions, are prepared by a Friedel-Crafts reaction of an aromatic or heteroaromatic, such as benzene, biphenyl or diphenyl ether, with phosphorus trihalides, preferably phosphorus trichloride, in the presence of a Friedel-Crafts catalyst such as aluminum chloride, zinc chloride, iron chloride etc., and subsequent reaction with the phenols underlying the structures (IX) and (VI). Also explicitly included are those mixtures with phosphites which form according to the reaction sequence mentioned from excess phosphorus trihalide and the above-described phenols.

From this group of compounds, preference is given in turn to the following structures (XII) and (XIII):

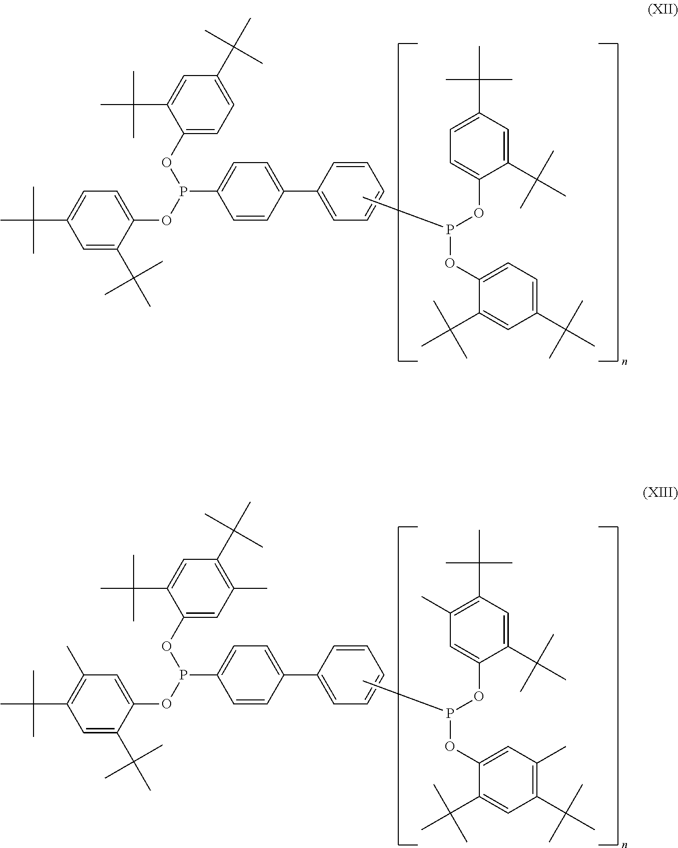

where n may be 0 or 1 and these mixtures may optionally further comprise proportions of the compound (XIV) and/or (XV):

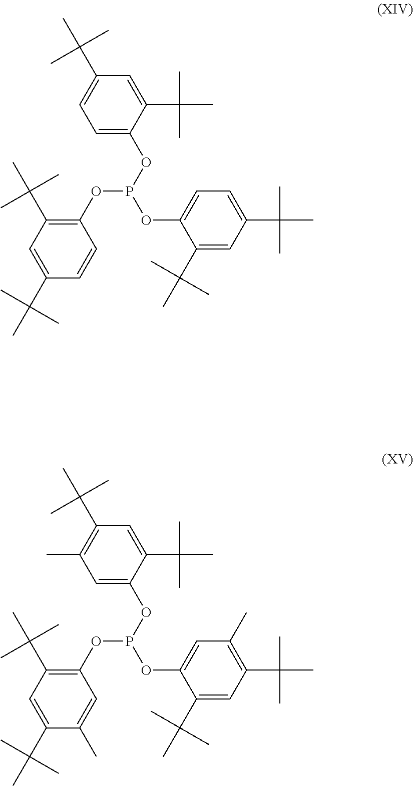

Suitable components G) are esters or salts of long-chain aliphatic carboxylic acids (fatty acids) which typically have chain lengths of C₁₄ to C₄₀. The esters are reaction products of the carboxylic acids mentioned with standard polyhydric alcohols, for example ethylene glycol, glycerol, trimethylolpropane or pentaerythritol. Useful salts of the carboxylic acids mentioned are in particular alkali metal or alkaline earth metal salts or aluminum and zinc salts.

Preferred components G) are esters or salts of stearic acid, for example glyceryl monostearate or calcium stearate.

Component G) preferably also comprises reaction products of montan wax acids with ethylene glycol.

The reaction products are preferably a mixture of ethylene glycol mono-montan wax ester, ethylene glycol di-montan wax ester, montan wax acids and ethylene glycol.

Component G) also preferably comprises reaction products of montan wax acids with a calcium salt.

The reaction products are more preferably a mixture of 1,3-butanediol mono-montan wax ester, 1,3-butanediol di-montan wax ester, montan wax acids, 1,3-butanediol, calcium montanate and the calcium salt.

The compositions of the invention as claimed in one or more of claims 1 to 20 preferably have a glow wire ignition temperature (GWIT) according to IEC 60695-2-13 of 775° C. or more at a specimen thickness of 0.4-3 mm.

The aforementioned additives can be introduced into the polymer in a wide variety of different process steps. For instance, it is possible in the case of polyamides, at the start or at the end of the polymerization/polycondensation or in a subsequent compounding operation, to mix the additives into the polymer melt. In addition, there are processing operations in which the additives are not added until a later stage. This is practiced especially in the case of use of pigment or additive masterbatches. There is also the possibility of applying additives, particularly in pulverulent form, to the polymer pellets, which may be warm as a result of the drying operation, by drum application.

The invention finally also relates to a process for producing flame-retardant polymer moldings, wherein inventive flame-retardant polymer molding compositions are processed by injection molding (for example injection molding machine of the Aarburg Allrounder type) and pressing, foam injection molding, internal gas pressure injection molding, blow molding, film casting, calendering, laminating or coating at elevated temperatures to give the flame-retardant polymer molding.

### EXAMPLES

### 1. Components Used

Commercial polyamides (component A)):

Nylon-6,6 (PA 6,6-GR): Ultramid® A27 (from BASF SE, Germany)
Nylon-6: Ultramid® B27 (from BASF SE, Germany)
Nylon-6T/6,6: Vestamid HTplus M1000 (from Evonik, Germany)
Nylon-10T: Vestamid HTplus M3000 (from Evonik, Germany)

Component E): PPG HP 3610 glass fibers with diameter 10 μm and length 4.5 mm (from PPG, the Netherlands)

Flame retardant (component B)):

aluminum salt of diethylphosphinic acid, referred to hereinafter as DEPAL

Flame retardant (component C)):

aluminum salt of phosphorous acid, referred to hereinafter as PHOPAL

Flame retardant (component D)):

Delacal 360 (melam)
Delacal 420 (melem)
Delacal 500 (melon), all from Delamin Ltd., UK

Comparison: MPP, melamine polyphosphate, Melapur® 200/70, from BASF AG, Germany

Phosphonites (component F)): Sandostab® P-EPQ, from Clariant GmbH, Germany

Wax components (component G)):

Licowax® E, from Clariant Produkte (Deutschland) GmbH, Germany (esters of montan wax acid)

### 2. Production, Processing and Testing of Flame-Retardant Polyamide Molding Compounds

The flame retardant components were mixed with the phosphonite, the lubricants and stabilizers in the ratio specified in the table and incorporated via the side intake of a twin-screw extruder (Leistritz ZSE 27/44D) into PA 6,6 at temperatures of 260 to 310° C., and into PA 6 at 250-275° C. The glass fibers were added via a second side intake. The homogenized polymer strand was drawn off, cooled in a water bath and then pelletized.

After sufficient drying, the molding compounds were processed to test specimens on an injection molding machine (Arburg 320 C Allrounder) at melt temperatures of 250 to 300° C., and tested and classified for flame retardancy using the UL 94 test (Underwriter Laboratories).

The UL 94 fire classifications are as follows:
V-0: afterflame time never longer than 10 sec, total of afterflame times for 10 flame applications not more than 50 sec, no flaming drops, no complete consumption of the specimen, afterglow time for specimens never longer than 30 sec after end of flame application.
V-1: afterflame time never longer than 30 sec after end of flame application, total of afterflame times for 10 flame applications not more than 250 sec, afterglow time for specimens never longer than 60 sec after end of flame application, other criteria as for V-0.
V-2: cotton indicator ignited by flaming drops, other criteria as for V-1. not classifiable (ncl): does not comply with fire classification V-2.

Glow wire resistance was determined using the GWFI (glow wire flammability index) glow wire test according to IEC 60695-2-12 and the glow wire ignitability test GWIT (glow wire ignition temperature) according to IEC 60695-2-13. In the GWFI test, using three test specimens (for example using plates of geometry 60×60×1.5 mm), with the aid of a glow wire, at temperatures between 550 and 960° C., the maximum temperature at which an afterflame time of 30 seconds is not exceeded and the sample does not give off burning drops is determined. In the GWIT test, in a comparable measurement procedure, the glow wire ignition temperature 25 K higher (30 K between 900° C. and 960° C.) than the maximum glow wire temperature that does not lead to ignition in 3 successive tests even during the contact time of the glow wire is reported. Ignition is regarded here as a flame having a burning time of 5 seconds or more.

The flowability of the molding compositions was determined by finding the melt volume flow rate (MVR) at 275° C./2.16 kg. Higher MVR values mean better flowability in the injection molding process. However, a significant rise in the MVR value can also suggest polymer degradation.

All tests in the respective series, unless stated otherwise, were performed under identical conditions (temperature programs, screw geometry, injection molding parameters, etc.) for comparability.

The results in which the flame retardant-stabilizer mixture according to the invention was used are listed in examples 11-13. All amounts are reported as % by weight and are based on the polymer molding compound including the flame retardants, additives and reinforcers.

TABLE 1
N 6,6 GF 30 test results. C1-C4 are comparative examples,
I1 to I3 are polyamide moulding compound of the invention

| | C1 | C2 | C3 | C4 | I1 | I2 | I3 |
|---|---|---|---|---|---|---|---|
| A: Nylon-6,6 [% by wt.] | 49.55 | 49.55 | 49.55 | 39.55 | 39.55 | 49.30 | 49.30 |
| A: Nylon-6 [% by wt.] | | | | 10 | 10 | | |
| E: HP3610 glass fibers [% by wt.] | 30 | 30 | 30 | 30 | 30 | 30 | 30 |
| B: DEPAL [% by wt.] | 20 | 17 | 15 | 10 | 14 | 12 | 12 |
| C: PHOPAL [% by wt.] | | 3 | | | 3 | 3 | 3 |
| MPP [% by wt.] | | | | 10 | | | |
| D1: Delacal 360 [% by wt.] | | | 5 | | 3 | 5 | |
| D2: Delacal 420 [% by wt.] | | | | | | | 5 |
| G: Licowax E [% by wt.] | 0.25 | 0.25 | 0.25 | 0.25 | 0.25 | 0.25 | 0.25 |
| F: P-EPQ [% by wt.] | 0.20 | 0.20 | 0.20 | 0.20 | 0.20 | 0.20 | 0.20 |

Test results

| | | | | | | | |
|---|---|---|---|---|---|---|---|
| UL 94 at thickness 0.4 mm | V-1 | V-0 | V-1 | V-0 | V-0 | V-0 | V-0 |
| GWFI at thickness 0.4 mm [° C.] | 850 | 960 | 850 | 960 | 960 | 960 | 960 |
| MVR 275° C./2.16 kg | 4 | 5 | 6 | 17 | 9 | 8 | 10 |
| GWIT at thickness 0.75 mm [° C.] | 700 | 725 | 725 | 775 | 800 | 800 | 775 |
| Color of the specimens** | yellow | yellow | white | white | white | white | white |
| Exudation* | none | none | none | marked | none | none | none |
| CTI [volts] | 600 | 600 | 550 | 550 | 600 | 600 | 600 |
| Impact resistance [kJ/m²] | 60 | 63 | 58 | 61 | 68 | 71 | 69 |
| Notched impact resistance [kJ/m²] | 12 | 11 | 11 | 10 | 14 | 14 | 12 |

*14 days 100% humidity 70° C.
**yellow: yellowness index >20

Only by virtue of the inventive combination of polyamide, glass fibers, DEPAL, PHOPAL and melem or melam are polyamide molding compounds obtained that attain the UL 94 V-0 fire class at 0.4 mm and simultaneously have a GWIT greater than 775° C. and CTI 600 volts, impact resistance greater than 65 kJ/m², notched impact resistance greater than 10 kJ/m², and do not exhibit any coloring (yellowness index <20) or any exudation. Moreover, only these compositions of the invention have the desired whiteness. The use of DEPAL without PHOPAL (C1) does not achieve V-0; the combination of DEPAL with MPP (C4) does achieve V-0 and GWIT 775° C., but the polyamide molding compound shows coloring and exudation. A CTI of 600 V is likewise not attained. The combination of DEPAL with PHOPAL does not attain GWIT >=775° C.; the combination of DEPAL with melam (C3) does not fulfill UL 94 V-0 and GWIT 775° C.

TABLE 2
PA 6 GF 30 test results. C5-C7 are comparative examples, I4
and I5 are polyamide moulding compound of the invention

| | C5 | C6 | C7 | I4 | I5 |
|---|---|---|---|---|---|
| A: Nylon-6 [% by wt.] | 49.55 | 49.55 | 49.55 | 49.55 | 49.55 |
| E: HP3610 glass fibers [% by wt.] | 30 | 30 | 30 | 30 | 30 |
| B: DEPAL [% by wt.] | 20 | 12 | 17 | 12 | 14 |
| C: PHOPAL [% by wt.] | | | 3 | 3 | 3 |
| MPP [% by wt.] | | 8 | | | |
| D2: Delacal 420 [% by wt.] | | | | 5 | 3 |
| G: Licowax E [% by wt.] | 0.25 | 0.25 | 0.25 | 0.25 | 0.25 |
| F: P-EPQ [% by wt.] | 0.20 | 0.20 | 0.20 | 0.20 | 0.20 |

Test results

| | | | | | |
|---|---|---|---|---|---|
| UL 94 at thickness 0.4 mm | V-1 | V-0 | V-0 | V-0 | V-0 |
| GWIT at thickness 0.75 mm [° C.] | 700 | 775 | 725 | 800 | 775 |
| MVR 250° C./2.16 kg | 5 | 12 | 5 | 10 | 9 |
| Exudation* | none | marked | none | none | none |
| CTI [volts] | 600 | 550 | 600 | 600 | 600 |
| Impact resistance [kJ/m²] | 61 | 59 | 62 | 67 | 65 |
| Notched impact resistance [kJ/m²] | 11 | 9.8 | 10 | 12 | 12 |

*14 days, 100% humidity, 70° C.

The experiments in nylon-6 show a similar picture: only the inventive combination of nylon-6 with glass fibers, DEPAL, PHOPAL and melem gives molding compounds which simultaneously have UL 94 V-0 at 0.4 mm, GWIT >=775° C., CTI 600 V, no exudation, good flowability and good mechanical values.

TABLE 3
PA 10T GF 30 test results. C8-C10 are comparative examples,
I6 and I7 are polyamide moulding compound of the invention

| | C8 | C9 | C10 | I6 | I7 |
|---|---|---|---|---|---|
| A: Nylon-10T [% by wt.] | 49.55 | 49.55 | 49.55 | 49.55 | 49.55 |
| E: HP3610 glass fibers [% by wt.] | 30 | 30 | 30 | 30 | 30 |
| B: DEPAL [% by wt.] | 20 | 12 | 17 | 12 | 14 |
| C: PHOPAL [% by wt.] | | | 3 | 3 | 3 |
| D2: Delacal 420 [% by wt.] | | 8 | | 5 | 3 |
| G: Licowax E [% by wt.] | 0.25 | 0.25 | 0.25 | 0.25 | 0.25 |
| F: P-EPQ [% by wt.] | 0.20 | 0.20 | 0.20 | 0.20 | 0.20 |

Test results

| | | | | | |
|---|---|---|---|---|---|
| UL 94 at thickness 0.4 mm | V-1 | V-1 | V-0 | V-0 | V-0 |
| GWIT at thickness 0.75 mm [° C.] | 750 | 750 | 750 | 800 | 825 |
| Exudation* | none | marked | none | none | none |
| CTI [volts] | 600 | 550 | 600 | 600 | 600 |
| Impact resistance [kJ/m²] | 70 | 61 | 61 | 71 | 68 |
| Notched impact resistance [kJ/m²] | 9 | 8 | 9 | 8 | 9 |

*14 days, 100% humidity, 70° C.

In nylon-10T as well, only the inventive combination of polyamide with glass fibers, DEPAL, PHOPAL and melem gives molding compounds which simultaneously have UL 94 V-0 at 0 4 mm, GWIT >=775° C., CTI 600 V, no exudation and good mechanical values. The combination of DEPAL and MPP cannot be processed in PA 10T.

TABLE 4
PA 6T/66 GF 30 test results. C11-C13 are comparative examples,
I8 and I9 are polyamide moulding compound of the invention

| | C11 | C12 | C13 | I8 | I9 |
|---|---|---|---|---|---|
| A: Nylon-6T/66 [% by wt.] | 54.55 | 54.55 | 54.55 | 54.55 | 54.55 |
| E: HP3610 glass fibers [% by wt.] | 30 | 30 | 30 | 30 | 30 |
| B: DEPAL [% by wt.] | 15 | 10 | 12 | 10 | 8 |
| C: PHOPAL [% by wt.] | | | 3 | 2 | 2 |
| D2: Delacal 500 [% by wt.] | | 5 | | 3 | 5 |
| G: Licowax E [% by wt.] | 0.25 | 0.25 | 0.25 | 0.25 | 0.25 |
| F: P-EPQ [% by wt.] | 0.20 | 0.20 | 0.20 | 0.20 | 0.20 |

Test results

| | | | | | |
|---|---|---|---|---|---|
| UL 94 at thickness 0.4 mm | V-0 | V-1 | V-0 | V-0 | V-0 |
| GWIT at thickness 0.75 mm [° C.] | 750 | 750 | 750 | 825 | 800 |
| Exudation* | none | none | none | none | none |
| CTI [volts] | 600 | 600 | 600 | 600 | 600 |
| Impact resistance [kJ/m²] | 62 | 58 | 61 | 63 | 62 |
| Notched impact resistance [kJ/m²] | 7 | 7 | 8 | 8 | 7 |

*14 days, 100% humidity, 70° C.

In nylon-6T/6,6, the inventive combination of polyamide with glass fibers, DEPAL, PHOPAL and melon gives molding compounds which simultaneously have UL 94 V-0 at 0 4 mm, GWIT >=775° C., CTI 600 V, no exudation and good mechanical values. The combination of DEPAL and MPP cannot be processed in PA 6T/66 either.

Overall, only the combinations of the invention attain all the parameters to be fulfilled.

1. A flame-retardant polyamide composition comprising as component A) 1% to 96% by weight of one or more thermoplastic polyamides, as component B) 2% to 25% by weight of a dialkylphosphinic salt of the formula (I) 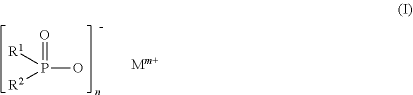
wherein
R¹ and R² are the same or different and are C₁-C₁₈-alkyl in linear, branched or cyclic form, C6-C18-aryl, C7-C18-arylalkyl and/or C7-C18-alkylaryl,
M is Mg, Ca, Al, Sb, Sn, Ge, Ti, Zn, Fe, Zr, Ce, Bi, Sr, Mn, Li, Na, K, a protonated nitrogen base or a mixture thereof;
m is 1 to 4;
n is 1 to 4;
as component C) 1% to 20% by weight of a salt of phosphorous acid,
as component D) 1% to 20% by weight of one or more condensation products of melamine,
as component E) 0% to 50% by weight of filler, reinforcer or a mixture thereof,
as component F) 0% to 2% by weight of phosphite or phosphonite or mixtures thereof, and as component G) 0% to 2% by weight of an ester or salt of long-chain aliphatic carboxylic acids having a chain length of C₁₄ to C₄₀, where the sum total of the components is always 100% by weight.

2. The flame-retardant polyamide composition as claimed in claim 1, comprising
15% to 89.9% by weight of component A),
5% to 20% by weight of component B),
2% to 10% by weight of component C),
2% to 10% by weight of component D),
1% to 50% by weight of component E),
0% to 2% by weight of component F) and
0.1% to 1% by weight of component G).

3. The flame-retardant polyamide composition as claimed in claim 1, comprising
15% to 75.8% by weight of component A),
5% to 20% by weight of component B),
2% to 10% by weight of component C),
2% to 10% by weight of component D),
15% to 35% by weight of component E),
0.1% to 1% by weight of component F) and
0.1% to 1% by weight of component G).

4. The flame-retardant polyamide composition as claimed in claim 1, comprising
35% to 65.8% by weight of component A),
5% to 20% by weight of component B),
2% to 7% by weight of component C),
2% to 7% by weight of component D),
25% to 35% by weight of component E),
0.1% to 0.5% by weight of component F) and
0.1% to 0.5% by weight of component G).

5. The flame-retardant polyamide composition as claimed in claim 1, comprising
35% to 96% by weight of component A),
2% to 25% by weight of component B),
1% to 20% by weight of component C),
1% to 20% by weight of component D),
0% to 50% by weight of component E),
0% to 2% by weight of component F) and
0% to 2% by weight of component G).

6. The flame-retardant polyamide composition as claimed in claim 1, having a comparative tracking index (CTI) of greater than 500 volts, measured according to International Electrotechnical Commission Standard IEC 60112/3.

7. The flame-retardant polyamide composition as claimed in claim 1, having a V-0 assessment according to UL-94 at a specimen thickness of 3.2 mm to 0.4 mm.

8. The flame-retardant polyamide composition as claimed in claim 1, having a glow wire flammability index (GWFI) according to IEC 60695-2-12 of 850° C. or more at a specimen thickness of 0.4 to 3 mm.

9. The flame-retardant polyamide composition as claimed in claim 1, having a glow wire ignition temperature index (GWIT) according to IEC 60695-2-13 of 750° C. or more at a specimen thickness of 0.4 to 3 mm.

10. The flame-retardant polyamide composition as claimed in claim 1, wherein the polyamide (PA) is selected from the group consisting of PA 6, PA 6,6, PA 4,6, PA 12, PA 6,10, PA 6T/66, PA 6T/6, PA 4T, PA 9T, PA 10T, polyamide copolymers, polyamide blends, and combinations thereof.

11. The flame-retardant polyamide composition as claimed in claim 1, wherein component A) is nylon-6,6 or copolymers or polymer blends of nylon-6,6 and nylon-6.

12. The flame-retardant polyamide composition as claimed in claim 1, wherein component A) is a polyamide PA 6T/66, PA 6T/6, PA 4T, PA 9T, PA 10T or a mixture thereof.

13. The flame-retardant polyamide composition as claimed in claim 1, wherein component D) comprises melam, melem, melon or a mixture thereof.

14. The flame-retardant polyamide composition as claimed in claim 1, wherein component D) is melem.

15. The flame-retardant polyamide composition as claimed in claim 1, wherein, in component B), R¹ and R² are the same or different and are methyl, ethyl, n-propyl, isopropyl, n-butyl, tert-butyl, n-pentyl, phenyl or a mixture thereof.

16. The flame-retardant polyamide composition as claimed in claim 1, wherein the salt of phosphorous acid, component C, conforms to the formula (II)
[HP(═O)O₂]²⁻M^{m+} (II)
wherein
M is Mg, Ca, Al, Sb, Sn, Ge, Ti, Zn, Fe, Zr, Ce, Bi, Sr, Mn, Li, Na, K or a mixture thereof.

17. The flame-retardant polyamide composition as claimed in one claim 1, wherein the salt of phosphorous acid, component C) is aluminum phosphite Al(H₂PO₃)₃, secondary aluminum phosphite Al₂(HPO₃)₃, aluminum phosphite tetrahydrate Al₂(HPO₃)₃*4 aq, aluminum phosphonate, basic aluminum phosphite Al(OH)(H₂PO₃)₂*2 aq, Al₇(HPO₃)₉(OH)₆(1,6-hexanediamine)_{1.5}*12H₂O, Al₂(HPO₃)₃*xAl₂O₃*nH₂O with x=1−2.27 and n=1-5, Al₄H₆P₁₆O₁₈ or a mixture thereof.

18. The flame-retardant polyamide composition as claimed in claim 1, wherein the salt of phosphorous acid comprises aluminum phosphites of the formulae (Ill), (IV), (V) wherein
Al₂(HPO₃)₃x(H₂O)_{q} Formula (III):
and
q is o to 4;
Al_{2.00}M_{z}(HPO₃)_{y}(OH)ᵥx(H₂O)_{w} Formula (IV)
and
M are alkali metal ions,
z is 0.01 to 1.5,
y is 2.63 to 3.5,
v is 0 to 2 and
w is 0 to 4;
Al_{2.00}(HPO₃)ᵤ(H₂PO₃)ₜx(H₂O)ₛ Formula (V)
and
u is 2 to 2.99 and
t is 2 to 0.01 and
s is 0 to 4,
comprises mixtures of aluminum phosphite of the formula (III) with sparingly soluble aluminum salts and nitrogen-free extraneous ions, mixtures of aluminum phosphite of the formula (V) with aluminum salts, mixtures of aluminum phosphite of the formulae (III), (IV), (V) or a mixture thereof with aluminum phosphite [Al(H₂PO₃)₃], with secondary aluminum phosphite [Al₂(HPO₃)₃], with basic aluminum phosphite [Al(OH)(H₂PO₃)₂*2 aq], with aluminum phosphite tetrahydrate [Al₂(HPO₃)₃*4 aq], with aluminum phosphonate, with Al₇(HPO₃)₉(OH)₆(1,6-hexanediamine)_{1.5}*12H₂O, with Al₂(HPO₃)₃*xAl₂O₃*nH₂O with x=1-2.27 and n=1-50, with Al₄H₆P₁₆O₁₈ or a mixture thereof.

19. The flame-retardant polyamide composition as claimed in claim 1, wherein component C) has an average particle size of 0.2 to 100 μm.

20. The flame-retardant polyamide composition as claimed in claim 1, wherein the reinforcing filler or reinforce, component E), comprises glass fibers.

21. The flame-retardant polyamide composition as claimed in claim 1, wherein the phosphonites, component F) are those of the general structure
R—[P(OR⁵)₂]ₘ (VI)
wherein
R is a mono- or polyvalent aliphatic, aromatic or heteroaromatic organic radical and
R⁵ is a compound of the structure (VII) 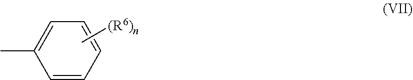
or the two R⁵ radicals form a bridging group of the structure (VIII) 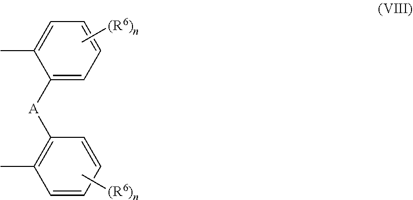
wherein
A is a direct bond, O, S, C₁₋₁₈-alkylene (linear or branched), C₁₋₁₈-alkylidene, linear or branched, wherein
R⁶ is independently C₁₋₁₂-alkyl (linear or branched), C₁₋₁₂-alkoxy, C₅₋₁₂-cycloalkyl or a mixture thereof and
n is 0 to 5 and
m is 1 to 4.

22. The flame-retardant polyamide composition as claimed in claim 1, wherein component G) comprises alkali metal, alkaline earth metal, aluminum and/or zinc salts of long-chain fatty acids having 14 to 40 carbon atoms and/or reaction products of long-chain fatty acids having 14 to 40 carbon atoms with polyhydric alcohols such as ethylene glycol, glycerol, trimethylolpropane, pentaerythritol or a mixture thereof.

23. The flame-retardant polyamide composition as claimed in claim 1, further comprises telomers and wherein the telomers are ethylbutylphosphinic acid, dibutylphosphinic acid, ethylhexylphosphinic acid, butylhexylphosphinic acid, ethyloctylphosphinic acid, sec-butylethylphosphinic acid, (1-ethylbutyl)butylphosphinic acid, ethyl(1-methylpentyl)phosphinic acid, di-sec-butylphosphinic acid (di-1-methylpropylphosphinic acid), propyl(hexyl)phosphinic acid, dihexylphosphinic acid, hexyl(nonyl)phosphinic acid, dinonylphosphinic acid, salts thereof with the metals Mg, Ca, Al, Sb, Sn, Ge, Ti, Zn, Fe, Zr, Ce, Bi, Sr, Mn, Li, Na, K or a mixture thereof.

24. A three-dimensional article comprising the composition as claimed in claim 1, comprising shaped bodies, injection moldings, extrusion compounds or extrudates.

25. A three dimensional article comprising a flame-retardant polyamide composition as claimed in claim 1, wherein the three dimensional article is selected from the group consisting of plug connectors, current-bearing components in power distributors, circuit boards, potting compounds, plug connectors, circuit breakers, lamp housings, capacitor housings, coil elements and ventilators for grounding contacts, plugs, printed circuit boards, housings for plugs, cables, flexible circuit boards, charging cables for mobile phones, motor covers and textile coatings.
